(19) United States
(12) Patent Application Publication
(10) Pub. No.: US 2026/0114441 A1
(43) Pub. Date: Apr. 30, 2026

(54) Cat Counter Barrier Device

(71) Applicant: January Bear, Weeki Wachee, FL (US)

(72) Inventor: January Bear, Weeki Wachee, FL (US)

(21) Appl. No.: 19/171,468

(22) Filed: Apr. 7, 2025

Related U.S. Application Data
(60) Provisional application No. 63/711,211, filed on Oct. 24, 2024.

(51) Int. Cl. A01M 29/30

(52) U.S. Cl. CPC A01M 29/30

(57) ABSTRACT

A cat counter barrier device is provided. The device is designed to prevent cats from accessing counters and other flat surfaces by providing a customizable and repositionable barrier. The device comprises at least one base with a flat bottom surface that may incorporate a textured, non-slip material or various fastening mechanisms such as adhesives, suction cups, or magnetic strips for stability. The base includes attachment points that secure removable panels using slots, clips, magnets, or interlocking tabs. The panels are constructed from scratch-resistant materials like polycarbonate or tempered glass and may feature odor-neutralizing coatings or phosphorescent elements for visibility. Additionally, decorative textures can be applied to enhance aesthetics. The system allows for modular configurations, where multiple panels connect to form a continuous barrier, ensuring adaptability to various counter layouts.

### CROSS-REFERENCE TO RELATED APPLICATION

The present application claims priority to, and the benefit of, U.S. Provisional Application No. 63/711,211, which was filed on Oct. 24, 2024, and is incorporated herein by reference in its entirety.

### FIELD OF THE INVENTION

The present invention relates generally to the field of animal barriers. More specifically, the present invention relates to a cat counter barrier device that prevents cats from accessing counters by using a customizable base with non-slip materials or fastening mechanisms and removable, scratch-resistant panels. Accordingly, the present disclosure makes specific reference thereto. Nonetheless, it is to be appreciated that aspects of the present invention are also equally applicable to other like applications, devices, and methods of manufacture.

### BACKGROUND

Cats frequently explore elevated surfaces such as countertops, tables, and shelves. This behavior can lead to several challenges for pet owners, including hygiene concerns, potential damage to valuable items, and safety hazards for both the cat and household members. Traditional methods of deterring cats, such as verbal reprimands or spraying water, may create stress for both the pet and owner without effectively preventing the behavior. Additionally, cats may knock over objects, leading to lost or broken belongings. In households with open kitchens, cats jumping onto counters can result in contamination of food preparation areas, increasing the risk of health issues. Moreover, curious cats may come into contact with hazardous objects such as lit candles, hot stovetops, or open dishwashers, posing a significant safety risk. Elderly or physically impaired cats may also struggle with stability on slick surfaces, leading to slips and falls. Due to these concerns, pet owners seek an effective and humane way to prevent cats from accessing certain surfaces without resorting to aversive training methods or physical punishment.

Therefore, there exists a long-felt need in the art for a cat counter barrier device that provides pet owners with an effective and decorative barrier to prevent cats from accessing countertops and other elevated surfaces. There also exists a long-felt need in the art for a cat counter barrier device that offers secure and adaptable installation methods to accommodate various household configurations. Moreover, there exists a long-felt need in the art for a cat counter barrier device that provides a humane, stress-free solution to deter cats from jumping onto restricted areas while ensuring household cleanliness and safety.

The subject matter disclosed and claimed herein, in one embodiment thereof, comprises a cat counter barrier device. The device is designed to prevent cats from accessing counters and other flat surfaces by providing a customizable and repositionable barrier. The device comprises at least one base with a flat bottom surface that may incorporate a textured, non-slip material or various fastening mechanisms such as adhesives, suction cups, or magnetic strips for stability. The base includes attachment points that secure removable panels using slots, clips, magnets, or interlocking tabs. The panels are constructed from scratch-resistant materials like polycarbonate or tempered glass and may feature odor-neutralizing coatings or phosphorescent elements for visibility. Additionally, decorative textures can be applied to enhance aesthetics. The system allows for modular configurations, where multiple panels connect to form a continuous barrier, ensuring adaptability to various counter layouts. A method of use involves placing the base on a surface, securing the panels, and connecting additional panels as needed to create a complete barrier.

In this manner, the cat counter barrier device of the present invention accomplishes all the foregoing objectives and provides a modular and repositionable barrier system that effectively deters cats from accessing countertops, tables, and other flat surfaces. More specifically, the base ensures stability without damaging household surfaces. The attachment of the panel to the base further forms a physical and visual deterrent that discourages cats from jumping onto restricted areas. The modular design of the device allows for customizable configurations by connecting multiple panels, enabling coverage of various counter layouts. Select openings within the barrier permit controlled access for cats to designated areas, such as sinks for drinking water. Additionally, the panels feature customizable textures and finishes to complement different home aesthetics. By providing a functional, adaptable, and humane solution, the cat counter barrier device helps pet owners maintain a clean, organized, and safe living environment while effectively managing cat behavior.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cat counter barrier device. The cat counter barrier device prevents cats from accessing counters and other flat surfaces by providing a customizable and repositionable barrier. The device is comprised of at least one base with a flat bottom surface that rests on a counter or similar surface. The bottom surface may include a textured, non-slip grip material for enhanced stability. In another embodiment, the base may be secured using fastening mechanisms such as adhesives, suction cups, clamp mounts, magnetic strips, hook-and-loop fasteners, or removable gel pads.

The base also includes at least one attachment point to receive a removable panel. The panel may be made from scratch-resistant material. The panel may include a decorative texture, decorative patterns, designs, etc. that may be printed, embossed, stamped, laser-etched, or applied using heat transfer printing.

In one embodiment, at least one panel can connect to two bases to form a continuous barrier. Another embodiment allows multiple panels to connect using attachment mechanisms such as male-and-female fasteners, clips, clamps, or adhesives.

A method of use includes providing a cat counter barrier device with at least one base, attachment point, and removable panel. The base is positioned on a counter or flat surface, secured through a non-slip grip material or fastening mechanism. The removable panel is then attached to the base. If additional panels are needed, they may be connected to each other or between bases to create a continuous barrier.

Accordingly, the cat counter barrier device of the present invention is particularly advantageous as it provides a modular and repositionable barrier system that effectively deters cats from accessing countertops, tables, and other flat surfaces. More specifically, the base ensures stability without damaging household surfaces. The attachment of the panel to the base further forms a physical and visual deterrent that discourages cats from jumping onto restricted areas. The modular design of the device allows for customizable configurations by connecting multiple panels, enabling coverage of various counter layouts. Select openings within the barrier permit controlled access for cats to designated areas, such as sinks for drinking water. Additionally, the panels feature customizable textures and finishes to complement different home aesthetics. By providing a functional, adaptable, and humane solution, the cat counter barrier device helps pet owners maintain a clean, organized, and safe living environment while effectively managing cat behavior. In this manner, the cat counter barrier device overcomes the limitations of existing cat barrier techniques known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cat counter barrier device of the present invention in accordance with the disclosed architecture;

FIG. 2 illustrates a side view of a base of one potential embodiment of a cat counter barrier device of the present invention in accordance with the disclosed architecture;

FIG. 3 illustrates a side view of a removable panel of one potential embodiment of a cat counter barrier device of the present invention in accordance with the disclosed architecture;

FIG. 4 illustrates a perspective view of multiple of one potential embodiment of a cat counter barrier devices of the present invention arranged on a counter surface in accordance with the disclosed architecture; and

FIG. 5 illustrates a flowchart of a method of using one potential embodiment of a cat counter barrier device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cat counter barrier device that provides pet owners with an effective and decorative barrier to prevent cats from accessing countertops and other elevated surfaces. There also exists a long-felt need in the art for a cat counter barrier device that offers secure and adaptable installation methods to accommodate various household configurations. Moreover, there exists a long-felt need in the art for a cat counter barrier device that provides a humane, stress-free solution to deter cats from jumping onto restricted areas while ensuring household cleanliness and safety.

The present invention, in one exemplary embodiment, is comprised of a cat counter barrier device that restricts cats from accessing counters and other flat surfaces by offering a customizable and repositionable barrier. The device is comprised of at least one base with a flat bottom surface that rests on a counter or similar surface. The bottom surface may incorporate a textured, non-slip grip material to enhance stability. In another embodiment, the base may be secured using fastening mechanisms such as adhesives, suction cups, clamp mounts, magnetic strips, hook-and-loop fasteners, or removable gel pads.

The base also features at least one attachment point for securing a removable panel. The panel may be constructed from scratch-resistant material and may include decorative textures, patterns, or designs that are printed, embossed, stamped, laser-etched, or applied using heat transfer printing.

In one embodiment, at least one panel can connect to two bases to create a continuous barrier. Another embodiment enables multiple panels to connect through attachment mechanisms such as male-and-female fasteners, clips, clamps, or adhesives.

A method of use involves providing a cat counter barrier device with at least one base, attachment point, and removable panel. The base is placed on a counter or flat surface and secured using a non-slip grip material or fastening mechanism. The removable panel is then attached to the base. If additional panels are required, they may be connected to each other or between bases to form a continuous barrier.

The cat counter barrier device presents a modular and repositionable barrier system that effectively prevents cats from accessing countertops, tables, and other flat surfaces. The base ensures stability without causing damage to household surfaces, while the attached panel serves as both a physical and visual deterrent to discourage cats from jumping onto restricted areas. The modular design allows for customizable configurations by linking multiple panels, providing adaptable coverage for different counter layouts. Select openings within the barrier permit controlled access for cats to specific areas, such as sinks for drinking water. Additionally, the panels offer customizable textures and finishes to complement various home aesthetics. By delivering a functional, adaptable, and humane solution, the cat counter barrier device helps pet owners maintain a clean, organized, and safe living space while effectively managing cat behavior. This device addresses the limitations of existing cat barrier methods known in the art.

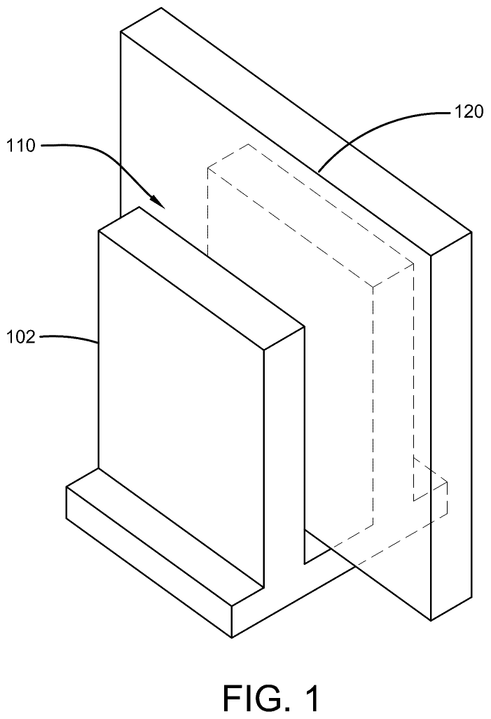

Referring initially to the drawings, FIG. 1 illustrates a perspective view of one potential embodiment of a cat counter barrier device 100 of the present invention in accordance with the disclosed architecture. The cat counter barrier device 100 is designed to prevent cats from accessing counters and other flat surfaces by providing a customizable and repositionable counter barrier. The device 100 is comprised of at least one base 102. The base 102 is comprised of a flat bottom surface 104 that allows the base 102 to rest on a kitchen counter or other flat surface such as a table. In one embodiment, the bottom surface 104 is comprised of a textured, non-slip grip material, such as, but not limited to, rubber, silicone, thermoplastic elastomer (TPE), cork, felt, or other high-friction polymeric compounds, to enhance stability and prevent slippage.

In another embodiment, the base 102 may be attached to the counter or other flat surfaces using a variety of fastening mechanisms 106 in lieu of or in addition to having a textured non-slip bottom surface 104. The fastening mechanisms 106 may include, but are not limited to, adhesives, suction cups, clamp mounts, magnetic strips, hook-and-loop fasteners, removable gel pads, etc. In one embodiment, the fastening mechanism 106 is a vacuum-sealing mechanism that secures the base 102 to the surface by creating an air-tight seal. In another embodiment, the base 102 is counterweighted to stabilize the device 100 without requiring direct adhesion to the surface.

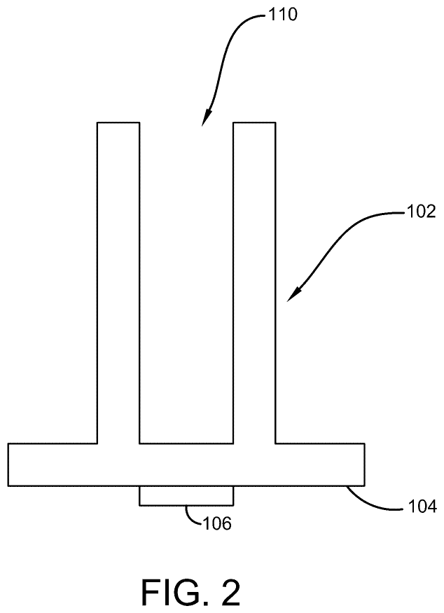

The base 102 is comprised of at least one attachment point 110 that receives at least one removable panel 120, as seen in FIG. 1. In one embodiment, the attachment point 110 is comprised of a channel or a groove, as seen in FIG. 2. In another embodiment, the attachment point 110 is comprised of a clip, a clamp, a magnet, an adhesive, an interlocking tab, or a slot-and-peg mechanism that secures the panel 120 to the base 102.

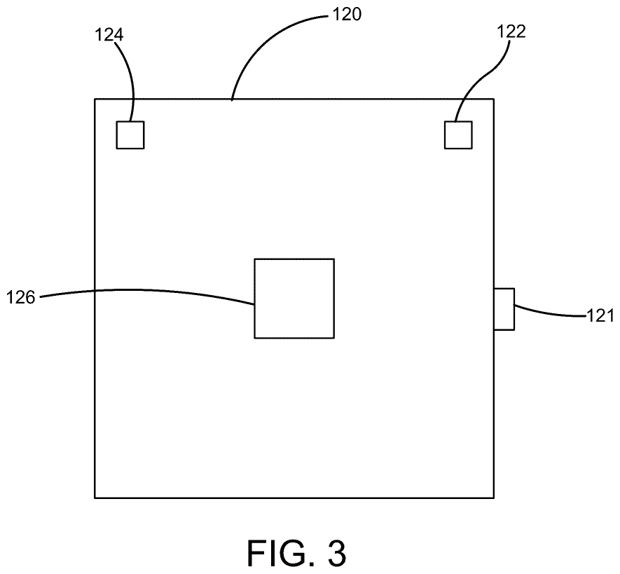

The panel 120 may be manufactured from scratch-resistant materials such as reinforced vinyl, acrylic, polycarbonate, PET plastic, tempered glass, or aluminum composite panels. These materials ensure longevity by resisting claw damage while remaining lightweight yet sturdy. Additionally, the panel 120 may feature an odor-neutralizing coating 122, as seen in FIG. 3, to help reduce pet-related odors in the surrounding area. In one embodiment, the odor-neutralizing coating 122 may be comprised of activated carbon, zeolite-based compounds, antimicrobial agents, or titanium dioxide coatings that help absorb and neutralize odors. In another embodiment, the coating 122 is an essential oils or a plant-based extract that provides a mild, pet-safe fragrance. For improved nighttime visibility, the panel 120 may be comprised of a phosphorescent coating 124 along any portion of the panel 120. The phosphorescent coating 124 may be applied in a pattern, such as a border, symbols, or a full surface treatment, to enhance visibility in low-light conditions.

The panel 120 may be comprised of a decorative texture 126. The texture 126 may be a simulative texture that gives the appearance that the panel 120 is made from a material such as, but not limited to, wood, brick, stone, frosted glass, woven fabric, or metallic finishes. In another embodiment, the texture 126 may be a decorative pattern or design that may be printed, embossed, stamped, laser-etched, or applied using heat transfer printing. The panels 120 may be manufactured in various sizes, shapes, and heights to accommodate different counter configurations.

In one embodiment, at least one panel 120 can be attached to attachment points 110 of two bases 102 to connect two bases 102, forming a continuous barrier. In another embodiment, multiple panels 120 may be connected to each other via attachment mechanisms 121 located on the panels 120 themselves, wherein the attachment mechanisms 121 may be any type of reciprocating fasteners such as, but not limited to, male-and-female, clips, clamps, adhesives, etc.

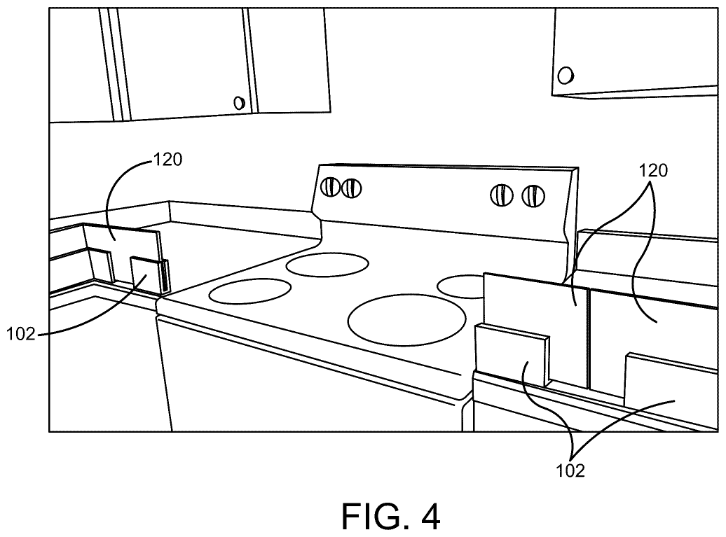

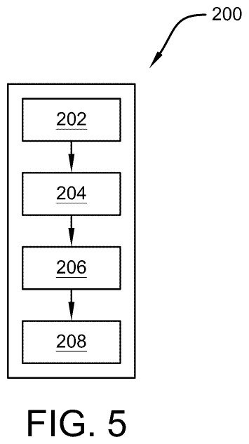

The present invention is also comprised of a method of using 200 the cat counter barrier device 100, as seen in FIG. 5. First, a device 100 is provided, comprised of at least one base 102, at least one attachment point 110, and at least one removable panel 120 [Step 202]. Then, the base 102 is positioned onto a counter or other flat surface as seen in FIG. 4, wherein the bottom surface 104 provides stability through a non-slip grip material or a fastening mechanism 106 [Step 204]. Next, at least one removable panel 120 is secured to the base 102 via the attachment point 110 [Step 206]. Then, if additional panels 120 are needed, the panels 120 may be attached to each other via attachment mechanisms 121, connected between bases 102 to form a continuous barrier, or placed next to one another (as seen in FIG. 4) [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cat counter barrier device” and “device” are interchangeable and refer to the cat counter barrier device 100 of the present invention.

Notwithstanding the foregoing, the cat counter barrier device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cat counter barrier device 100 as shown in the FIGS. are for illustrative purposes only, and that many other sizes and shapes of the cat counter barrier device 100 are well within the scope of the present disclosure. Although the dimensions of the cat counter barrier device 100 are important design parameters for user convenience, the cat counter barrier device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cat counter barrier device comprising:
a base having a flat bottom surface and an attachment point; and
a removable panel configured to be secured to the base via the attachment point.

2. The cat counter barrier device of claim 1, wherein the flat bottom surface is comprised of a textured material.

3. The cat counter barrier device of claim 1, wherein the flat bottom surface is comprised of a textured, non-slip material.

4. The cat counter barrier device of claim 3, wherein the textured, non-slip material is comprised of a rubber, a silicone, a TPE, a cork, or a felt.

5. The cat counter barrier device of claim 1, wherein the base is further comprised of a fastening mechanism.

6. The cat counter barrier device of claim 5, wherein the fastening mechanism is comprised of an adhesive, a suction cup, a clamp, a magnetic strip, a hook and loop fastener, or a gel pad.

7. The cat counter barrier device of claim 5, wherein the fastening mechanism is comprised of a vacuum-sealing mechanism.

8. The cat counter barrier device of claim 1, wherein the attachment point is comprised of a channel or a groove.

9. The cat counter barrier device of claim 1, wherein the attachment point is comprised of a clip, a clamp, a magnet, an adhesive, an interlocking tab, or a slot and peg mechanism.

10. The cat counter barrier device of claim 1, wherein the removable panel is comprised of a scratch-resistant material.

11. A cat counter barrier device comprising:
a base having a flat bottom surface and an attachment point; and
a first removable panel configured to be secured to the base via the attachment point, wherein the removable panel is comprised of a first attachment mechanism that attaches to a second removable panel.

12. The cat counter barrier device of claim 11, wherein the first removable panel is comprised of an odor-neutralizing coating.

13. The cat counter barrier device of claim 11, wherein the odor-neutralizing coating is comprised of an activated carbon, a zeolite-based compound, an antimicrobial agents, or titanium dioxide coating.

14. The cat counter barrier device of claim 11, wherein the first removable panel is comprised of an essential oil.

15. The cat counter barrier device of claim 11, wherein the first removable panel is comprised of a plant-based extract oil.

16. The cat counter barrier device of claim 11, wherein the first removable panel is comprised of a phosphorescent coating.

17. The cat counter barrier device of claim 11, wherein the first removable panel is comprised of a texture.

18. The cat counter barrier device of claim 11, wherein the first attachment mechanism is comprised of a male fastener, a female fastener, a clip, a clamp, or an adhesive.

19. The cat counter barrier device of claim 17, wherein the texture is comprised of a simulative texture of a wood, a brick, a stone, or a fabric.

20. A method of using a cat counter barrier device, the method comprising the following steps:
providing a cat counter barrier device comprised of a first removable panel, and a first base having a flat bottom surface and an attachment point;
positioning the first base onto a counter or a flat surface;
securing the first removable panel to the first base via the attachment point; and
attaching a second removable panel to the first removable panel or attaching a second base to the first base.
